(19) United States
(12) Patent Application Publication
(10) Pub. No.: US 2026/0277774 A1
(43) Pub. Date: Sep. 17, 2026

(54) METHOD, APPARATUS, DEVICE AND STORAGE MEDIUM FOR TEST CASE GENERATION

(71) Applicants: Beijing Zitiao Network Technology Co., Ltd., Beijing (CN); Lemon Inc., Grand Cayman (KY)

(72) Inventors: Lei WANG, Beijing (CN); Jun GE, Beijing (CN); Yi ZHANG, Los Angeles, CA (US); Zhangyi CHEN, Beijing (CN); Yi ZHAO, Beijing (CN); Huibin SU, Beijing (CN)

(21) Appl. No.: 19/473,451

(22) PCT Filed: May 18, 2024
(86) PCT No.: PCT/CN2024/094096

§ 371 Date: Oct. 7, 2025

(30) Foreign Application Priority Data
May 19, 2023 (CN) 202310576183.0

(51) Int. Cl. G06F 11/3668; G06F 40/169

(52) U.S. Cl. CPC G06F 11/3684; G06F 40/169

(57) ABSTRACT

A method, an apparatus, a device and a storage medium for test case generation are provided. The method includes: receiving a test case generation request for at least one functional block in an application; obtaining a data structure declaration related to a test case of the at least one functional block in response to the test case generation request; and generating, using a model, a plurality of test cases for the at least one functional block at least based on the data structure declaration and logical architecture information of the at least one functional block.

The present application claims priority to Chinese Patent Application No. 2023105761830, filed on May 19, 2023, and entitled “METHOD, APPARATUS, DEVICE AND STORAGE MEDIUM FOR TEST CASE GENERATION”, which is hereby incorporated by reference in its entirety.

### FIELD

Example embodiments of the present disclosure generally relate to the field of computer, and in particular, to a method, an apparatus, a device, and a computer-readable storage medium for test case generation.

### BACKGROUND

With the rapid development of Internet technology, various applications have become an important tool in people's daily life. Different applications have different functions, and users may implement specific services through specific applications with specific functions. An application creation platform, especially a low-code platform, may support users to efficiently develop applications, and implement operations such as application creation and application function adjustment. In the process of application development, sometimes it is necessary to test an application or a part of the application. A large number of test cases are usually required for testing.

### SUMMARY

In a first aspect of the present disclosure, a method for test case generation is provided. The method includes: receiving a test case generation request for at least one functional block in a target application; obtaining a data structure declaration related to a test case of the at least one functional block in response to the test case generation request; and generating, using a model, a plurality of test cases for the at least one functional block based at least on the data structure declaration and logical architecture information of the at least one functional block.

In a second aspect of the present disclosure, an apparatus for test case generation is provided. The apparatus includes: a request receiving module configured to receive a test case generation request for at least one functional block in a target application; a declaration obtaining module configured to obtain a data structure declaration related to a test case of the at least one functional block in response to the test case generation request; and a case generating module configured to generate, using a model, a plurality of test cases for the at least one functional block based at least on the data structure declaration and logical architecture information of the at least one functional block.

In a third aspect of the present disclosure, an electronic device is provided. The device includes at least one processing unit; and at least one memory coupled to the at least one processing unit and storing instructions for execution by the at least one processing unit, the instructions, when executed by the at least one processing unit, causing the electronic device to perform the method according to the first aspect.

In a fourth aspect of the present disclosure, a computer-readable storage medium is provided. The medium has a computer program stored thereon, and the computer program, when executed by a processor, implements the method according to the first aspect.

It should be understood that the content described in this section is not intended to limit the key or important features of the embodiments of the present disclosure, nor is it intended to limit the scope of the present disclosure. Other features of the present disclosure will become readily understood through the following description.

### BRIEF DESCRIPTION OF DRAWINGS

The above and other features, advantages and aspects of the embodiments of the present disclosure will become more apparent when taken in conjunction with the drawings and with reference to the following detailed description. In the drawings, the same or similar reference numerals refer to the same or similar elements, in which:

FIG. 1 shows a schematic diagram of an example environment in which embodiments of the present disclosure may be implemented;

FIG. 2 shows a flowchart of a process of test case generation according to some embodiments of the present disclosure;

FIG. 3A shows a schematic diagram of an example interface for initiating a test case generation request according to some embodiments of the present disclosure;

FIG. 3B shows a schematic diagram of an example data structure declaration according to some embodiments of the present disclosure;

FIG. 4 shows a schematic diagram of related information of a test case according to some embodiments of the present disclosure;

FIG. 5 shows a schematic structural block diagram of an apparatus for test case generation according to some embodiments of the present disclosure; and

FIG. 6 shows a block diagram of an electronic device in which one or more embodiments of the present disclosure may be implemented.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms and should not be interpreted as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term “include/comprise” and its similar terms should be understood as open inclusion, that is, “include/comprise but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may be included below.

Herein, unless explicitly stated, performing a step “in response to A” does not mean that the step is performed immediately after “A”, but may include one or more intermediate steps.

It may be understood that the data involved in the technical solution (including but not limited to the data itself, the acquisition, use, storage or deletion of the data) should comply with requirements of corresponding laws and regulations and related regulations.

It may be understood that before using the technical solutions disclosed in the embodiments of the present disclosure, the type, scope of use, usage scenario, and the like of the information involved in the present disclosure should be informed to relevant users and authorization from relevant users should be obtained through appropriate means according to relevant laws and regulations, where the relevant users may include any type of rights holder, such as individuals, enterprises, groups, etc.

For example, when receiving an active request from a user, prompt information is sent to a relevant user to explicitly prompt the relevant user that the operation requested to be performed will require acquisition and use of information of the relevant user, so that the relevant user can independently choose whether to provide information to software or hardware such as an electronic device, an application, a server or a storage medium that performs the operation of the technical solution of the present disclosure according to the prompt information.

As an optional but non-restrictive implementation, the way of sending prompt information to the relevant user in response to receiving an active request from the relevant user may be, for example, a pop-up window, and the prompt information may be presented in text in the pop-up window. In addition, the pop-up window may also carry a selection control for the user to select “agree” or “disagree” to provide information to the electronic device.

It may be understood that the above process of notifying and obtaining user authorization is only illustrative and does not constitute a limitation on the implementations of the present disclosure, and other ways that meet the requirements of relevant laws and regulations may also be applied to the implementations of the present disclosure.

A test case is a set of test inputs, execution conditions, and expected results prepared for a test target when an application is developed and is used to verify whether software meets a specific requirement.

Test case writing is usually done manually. Specifically, a tester confirms the input and expected output required for the function execution of the application under test, manually provides a complete test case set, and then drives the application under test to run the test case for testing. This process is slow and costly.

According to the embodiments of the present disclosure, an improved solution for test case generation in an application creation platform is provided. According to this solution, a test case generation request for at least one functional block in a target application is received, and a related data structure declaration is obtained in response to the test case generation request. A plurality of test cases for the at least one functional block are generated by means of a model. In this way, the efficiency of test case generation may be improved, the difficulty of test case generation may be simplified, and efficient testing of part or all of an application can be achieved.

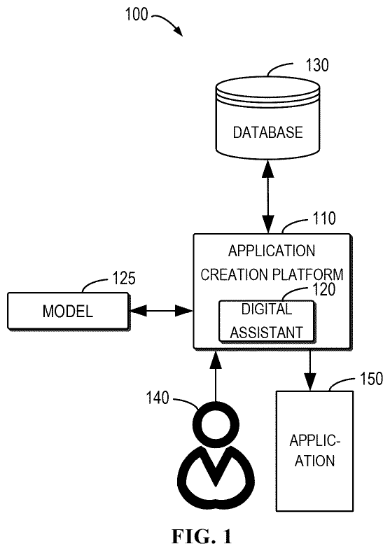

FIG. 1 shows a schematic diagram of an example environment 100 in which embodiments of the present disclosure may be implemented. As shown in FIG. 1, an application creation platform 110 may provide an application development and deployment environment. In some embodiments, the application creation platform 110 may be a low-code platform that provides a collection of tools for application development. The application creation platform 110 may support visual development of an application, allowing developers may skip the process of manual coding, accelerating the development cycle of the application and cost of the application. The application creation platform 110 may support any suitable platform for users to develop applications, for example, it may include a platform based on application platform as a service (aPaaS).

The application creation platform 110 may run on suitable electronic devices. The electronic device here may be any type of device with computing power, including a terminal device or a server-side device. The terminal device may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination of the preceding, including accessories and peripherals of these devices or any combination thereof. The server-side device may include, for example, a computing system/server, such as a mainframe, an edge computing node, a computing device in a cloud environment, etc. In some embodiments, the application creation platform 110 may be implemented based on cloud services.

The application creation platform 110 may be deployed locally on a user's terminal device, and/or may be supported by a remote server. In some embodiments, the terminal device may run a client of the application creation platform 110, and the client may support the interaction between the user and the application creation platform 110. In a case where the application creation platform 110 runs locally on the user's terminal device, the user may directly interact with the local application creation platform 110 by using the client. In a case where the application creation platform 110 runs on a server-side device, the server-side device may implement the supply of services to the client running on the terminal device based on a communication connection with the terminal device.

The application creation platform 110 may be deployed with a digital assistant 120. A user 140 may interact with the digital assistant 120 via the application creation platform 110. The digital assistant 120 is used for conversations with the user 140. A client of the application creation platform 110 may present an interaction window, such as a chat window, between the user 140 and the digital assistant 120 in a client interface. The digital assistant 120, as an intelligent assistant, has capabilities of intelligent conversation and information processing. The user 140 may enter a chat message in the chat window, and the digital assistant 120 provides a reply message in response to the chat message from the user.

In the application creation platform 110, the digital assistant 120 may be invoked or awakened by appropriate means (for example, shortcut keys, buttons, or voice) to present a chat window with the user. In some embodiments, the digital assistant 120 may be included in a contact list of the current user on the application creation platform 110 as a contact of the user, or be included in a information flow of a chat component. By selecting the digital assistant 120, a chat window with the digital assistant 120 may be initiated. In some embodiments, the digital assistant 120 may also be initiated in one or more components supported by the application creation platform 110, so as to present a chat window with the digital assistant 120.

The application creation platform 110 may obtain interaction information (including a chat message from the user and a reply message from the digital assistant 120) between the user 140 and the digital assistant 120 in the chat window. In some embodiments, the application creation platform 110 may understand the chat message from the user by means of a model 125 and determine a next operation to be performed. The application creation platform 110 may interact with the model 125 to provide a model input to the model 125 and obtain a corresponding model output from the model 125. The model 125 may run locally on the application creation platform 110 or on a remote server. In some embodiments, the model 125 may be a machine learning model, a deep learning model, a learning model, a neural network, or the like. In some embodiments, the model 125 may be based on a language model (LM). The language model can have question answering capabilities by learning from a large amount of corpus. The model 125 may also be based on other suitable models.

A database 130 is used to store data or information required for application processing operations to be performed by the application creation platform 110. For example, the database 130 may store codes and description information corresponding to respective functional blocks for composing an application. The application creation platform 110 may also perform operations such as invoking, adding, deleting, and updating on the functional blocks in the database 130. The database 130 may also store operations that may be performed on different functional blocks. In an example, in a scenario where an application 150 is to be created, the application creation platform 110 may invoke corresponding functional blocks from the database 130 to build the application 150.

It should be understood that the structure and function of the environment 100 are described only for the purpose of illustration, without implying any limitation to the scope of the present disclosure.

As a low-code platform, the application creation platform turns the complex coding process into a relatively simpler drag-and-drop operation by encapsulating the implementation details of the underlying codes, compared with the traditional code-based development platform. Applications developed on such platforms also need to be tested, especially horizontal integration testing of data models, processes, pages, and permission management in the overall application or functional blocks. Conventionally, such testing requires a large amount of simulated data, and test data sets need to be manually generated after sufficient understanding of the interfaces between the relevant modules. In the embodiments of the present disclosure, it is expected to simplify the testing task, automatically and efficiently generate the required test cases with the help of the data generation capability of the model.

Some example embodiments of the present disclosure will be described in detail below with reference to examples of the drawings.

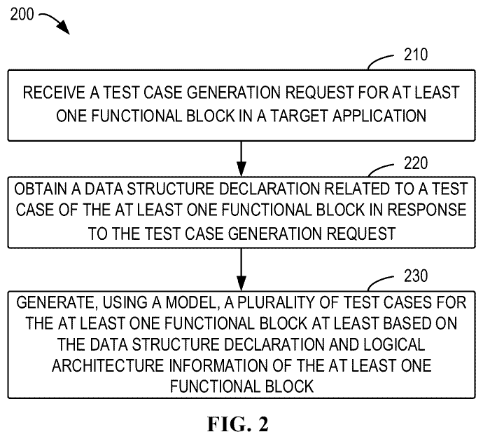

FIG. 2 shows a flowchart of a process 200 of test case generation according to some embodiments of the present disclosure. The process 200 may be implemented at the application creation platform 110. For ease of discussion, the process 200 will be described with reference to the environment 100 in FIG. 1.

At block 210, the application creation platform 110 receives a test case generation request for at least one functional block in a target application. The target application may be an application that is being developed or has been developed in the application creation platform 110.

The target application may include one or more functional blocks, also referred to as functional points or applets. Each functional block is configured to implement its own function, so as to jointly implement the service or task to be provided by the application. The application creation platform 110 may support users to develop various applications by customizing atomic components (also referred to as atomic modules) of respective functional blocks. The atomic component may be a finer-grained component in the functional block. The atomic component may include, for example, pages of the functional block, components of respective operation controls in the pages, data forms, data flow, permission configuration of roles, application program interfaces (APIs), and the like.

The test case generation request for the overall application or the test case generation request for one or more functional blocks in the application may be flexibly initiated in various ways. In some embodiments, the test case generation request for at least one functional block in the application may be obtained through the interaction between the user 140 and the digital assistant 120. The application creation platform 110 may receive a user input in a chat window between the user and the digital assistant 120, and the user input indicates the test case generation request for the at least one functional block of the application. The application creation platform 110 may also receive user input in other appropriate manners. In some embodiments, the user input may include multi-modal forms of input, such as text input (for example, input in the form of natural language), voice input, image input, video input, etc.

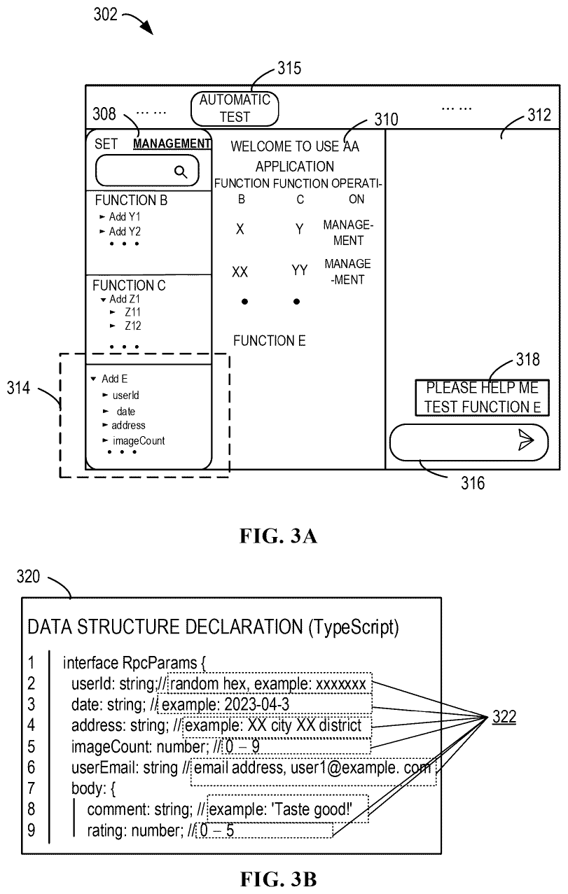

FIG. 3A shows a schematic diagram of an example interface 302 for initiating a test case generation request according to some embodiments of the present disclosure. In the interface 302, at least several regions may be divided, for example, a region 308 for presenting adjustment content associated with a functional block, a region 310 for presenting a visual page of a target application, and a region 312 for presenting a chat window for interacting with a user. In the region 308, configurable functional blocks included in the target application, atomic components involved in each functional block, and the like may be presented for configuration by the user.

The chat window between the user 140 and the digital assistant 120 is presented in the region 312, and the user 140 may use an input box 316 to input creation and adjustment requirements and testing requirements for the current application. For example, if a chat message 318 “please help me test a function E” input by the user is detected in the chat window, the application creation platform 110 may determine (for example, by means of the model 125) that the function E in the current application needs to be tested, and a test case needs to be generated for this test purpose. It is to be noted that the chat window between the user and the digital assistant may be presented by default in the client interface of the application creation platform 110, or may be presented based on any suitable request, such as voice wake-up, wake-up by a specific button, or it may be presented in a reduced size and zoomed in response to a request, and the like. These may all be configured according to actual application requirements.

In some embodiments, the application creation platform 110 may provide a test case generation control, such as an “automatic test” control 315 shown in FIG. 3A, a “generate test data” control, or any other control with other appropriate styles. If the application creation platform 110 detects a preset operation on the test case generation control associated with the at least one functional block in the application, it may determine that a test case request for the functional block is received. The preset operation may be, for example, a selection operation on the test case generation control and a selection operation on the one or more functional blocks to be tested. For example, in FIG. 3A, the user may be allowed to select the functional block E in the region 308 or select the functional block E in the region 310, and then click on an “automatic test” control 315 to initiate the test case generation request.

In the above example, although the description is made to the test case generation request for a specific functional block in the target application, in other embodiments, the test case generation request for the target application as a whole may also be initiated.

Returning to FIG. 2, at block 220, the application creation platform 110 obtains a data structure declaration related to a test case of the at least one functional block in response to the test case generation request. The data structure declaration is used to indicate the structure of the data contained in the test case, and may include, for example, input parameters, output parameters, types of parameters, invoked interfaces, and the like contained in the functional block.

FIG. 3B shows an example data structure declaration 320 for the functional block E to be tested in the example of FIG. 3A, which may specify an interface (for example, “RpcParams”) of the functional block E, various types of parameters (for example, “userId”, “date”, etc.), types of parameters (for example, a string or a number), etc. In some embodiments, the application creation platform 110 may provide the ability to automatically generate the data structure declaration for the application or a part of the application, or may generate the data structure declaration through other automated tools.

At block 230, the application creation platform 110 generates, using the model 125, a plurality of test cases for the at least one functional block at least based on the data structure declaration and logical architecture information of the at least one functional block.

In the embodiments of the present disclosure, the data generation capability of the model 125 is used to help achieve automatic test case generation. In order to enable the model to generate a test case that meets the requirements or provide the test data required for the test case, the input provided to the model 125 may include the data structure declaration and logical structure information of the functional block to be tested.

The logical architecture information of the functional block may indicate a function description, processing logic, and/or a calling relationship of the functional block, and the like, which is helpful for understanding the specific operating principle of the functional block. The application creation platform 110 may obtain the logical architecture information of the functional block by various appropriate means.

In some embodiments, the application creation platform 110 may extract the logical architecture information from annotation information associated with the application, and the annotation information at least describes the functions of one or more functional blocks in the target application. In some embodiments, the annotation information may be associated with the code of the target application, for example, the annotation information may be included in the code of the target application. In some embodiments, during the development process of the target application, the application creation platform 110 may support the user to determine the specific functions of the functional blocks in the application that the user wants to create and the required atomic components (for example, data forms, data flow, API, etc.) by interacting with the digital assistant 120. In this interaction process, the specific functions, logic, calling relationships, and the like of the functional blocks in the target application may be automatically extracted from the interaction information with the user and annotated. In some embodiments, a part or all of the annotation information may also be predefined by the developer of the target application. For example, the developer may add annotation information to one or more functional blocks in the target application during the development process of the target application, and the application creation platform 110 may obtain the annotation information of the target application when obtaining the target application.

In some embodiments, the application creation platform 110 may extract the logical architecture information from the target application by using the model 125. Specifically, the application creation platform 110 may obtain the code of the target application and/or description information about the target application, and provide the code and/or other description information of the target application to the model 125. In some embodiments, the application creation platform 110 may generate a prompt input for the model 125 based on the code of the target application and/or other description information. The application creation platform 110 may complete the generation of the prompt input by prompt engineering. The generated prompt input is provided to the model 125, so that the model 125 may determine the logical architecture information of the target application from the code and/or other description information of the target application, and feedback the logical architecture information to the application creation platform 110.

On the basis of obtaining the data structure declaration and the logical architecture information, in order to enable the model 125 to help generate the plurality of test cases, the application creation platform 110 may generate a prompt input for the model 125 at least based on the data structure declaration and the logical architecture information, and the prompt input also indicates a test case generation task. The application creation platform 110 may provide the prompt input to the model 125 and obtain related information for generating the plurality of test cases from the model 125. For example, the model 125 may feedback a large amount of test data required in the test cases, including input parameter values, output parameter values, and the like in respective test cases, and test scripts. The application creation platform 110 may generate the plurality of test cases at least based on the related information. Each test case may include test data, a test script, and the like for the one or more functional blocks to be tested, which may be assembled by an automated tool on the basis of the test data and the test script.

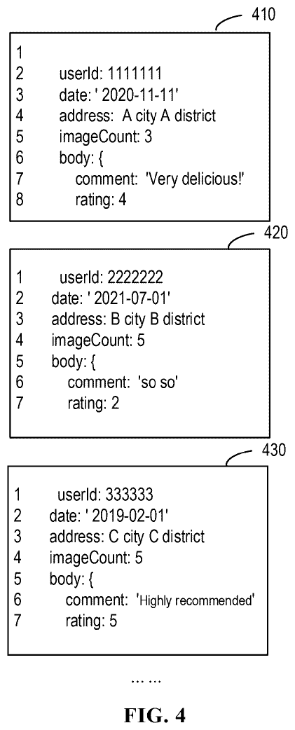

FIG. 4 shows a schematic diagram of related information of a test case according to some embodiments of the present disclosure. As shown in the figure, based on the data structure declaration in FIG. 3B, the model 125 may automatically generate multiple sets of data 410, 420, 430, etc. for the plurality of test cases.

In some embodiments, the application creation platform 110 may also obtain at least one test case sample for the at least one functional block to be tested. The test case sample may be used as an example to enable the model 125 to try to simulate the generation of test cases that conform to the test case sample. The application creation platform 110 may generate, using the model, the plurality of test cases based on the data structure declaration, the logical architecture information, and the at least one test case sample. For example, the prompt input for the model 125 may be generated based on the data structure declaration, the logical architecture information, and the at least one test case sample. In the example of FIG. 3B, a test case sample 322 for a functional block is shown, which gives an example of a respective part in the data architecture declaration.

In some embodiments, the application creation platform 110 may also obtain a test case constraint for the at least one functional block from a user. The test case constraint may be a limitation that a user imposes on various test aspects of the functional block, for example, it may include the total number of test cases to be generated, a relationship to be satisfied between input and output in the test case, and the like. Accordingly, the application creation platform 110 may generate the plurality of test cases, using the model 125, based on the data structure declaration, the logical architecture information, and the test case constraint (and may also be based on the test case sample). For example, the prompt input for the model 125 may be generated based on the data structure declaration, the logical architecture information, and the at least one test case sample.

In some embodiments, the application creation platform 110 may receive a test case constraint for the at least one functional block from the user in the chat window between the user and the digital assistant 120. In this way, the user may be allowed to give the test case constraint more conveniently and flexibly. In addition, with the help of the interaction capability of the digital assistant 120, the user may also be guided to correct or clarify the test case constraint when the user gives inappropriate test case constraints. Certainly, the test case constraint may also be received in any other appropriate manner.

In some embodiments, the application creation platform 110 may also present the plurality of generated test cases or an indication related to the plurality of test cases (for example, only present the test data as shown in FIG. 4, without presenting the underlying running script) in the chat window between the user and the digital assistant 120. In some embodiments, after generating the plurality of test cases, the application creation platform 110 may directly use the plurality of test cases to test the at least one functional block to be tested in the target application, or may perform the test after receiving the user's confirmation of the plurality of test cases. After the test is completed, the respective test results of the plurality of test cases and/or the overall test result may be provided to the user.

In the embodiments of the present disclosure, a plurality of test cases for an application or a functional block therein are automatically generated by means of a model, based on the data structure declaration and logical architecture information related to the application or the functional block therein to be tested. In this way, the efficiency of test case generation can be improved, the difficulty of test case generation may be simplified, and efficient testing of a part or all of an application can be achieved.

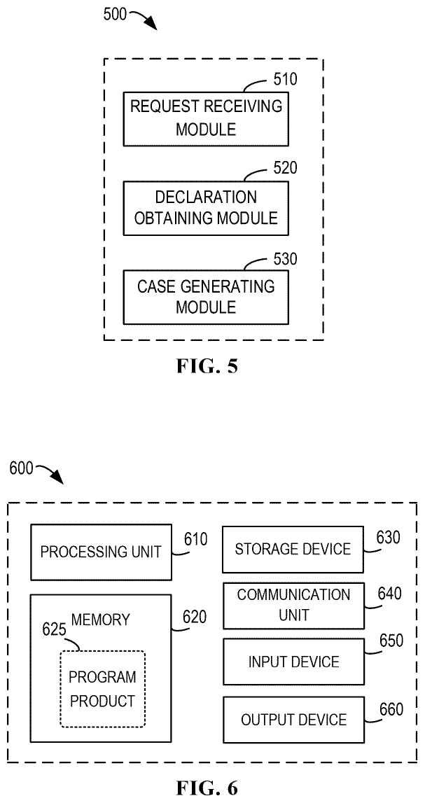

FIG. 5 shows a schematic structural block diagram of an apparatus 500 for test case generation according to some embodiments of the present disclosure. The apparatus 500, for example, may be implemented or included in the application creation platform 110. The various modules/components in the apparatus 500 may be implemented by hardware, software, firmware, or any combination thereof.

As shown in the figure, the apparatus 500 includes a request receiving module 510, which is configured to receive a test case generation request for at least one functional block in a target application. The apparatus 500 also includes a declaration obtaining module 520, which is configured to obtain a data structure declaration related to a test case of the at least one functional block in response to the test case generation request. The apparatus 500 also includes a case generating module 530, which is configured to generate, using a model, a plurality of test cases for the at least one functional block at least based on the data structure declaration and logical architecture information of the at least one functional block.

In some embodiments, the case generating module 530 includes: a task generating module configured to generate a prompt input for the model at least based on the data structure declaration and the logical architecture information, where the prompt input indicates a test case generation task; a prompt providing module configured to provide the prompt input to the model; a related information generating module configured to obtain, from the model, related information for generating the plurality of test cases; and a first case generating module configured to generate the plurality of test cases at least based on the related information.

In some embodiments, the case generating module 530 includes: a sample obtaining module configured to obtain at least one test case sample for the at least one functional block; and a second case generating module configured to generate, using the model, the plurality of test cases based on the data structure declaration, the logical architecture information, and the at least one test case sample.

In some embodiments, the case generating module 530 includes: a constraint obtaining module configured to obtain a test case constraint for the at least one functional block from a user; and a third case generating module configured to generate the plurality of test cases based on the data structure declaration, the logical architecture information and the test case constraint.

In some embodiments, the apparatus 500 further includes: an information extraction module configured to extract the logical architecture information from annotation information associated with the application, where the annotation information at least describes functions of one or more functional blocks in the target application.

In some embodiments, the logical architecture information indicates at least one of a function description, processing logic, or a calling relationship of the at least one functional block.

In some embodiments, the request receiving module 510 includes: an input receiving module configured to receive a user input in a chat window between a user and a digital assistant, where the user input indicates the test case generation request for the at least one functional block.

In some embodiments, the apparatus 500 further includes: a case presenting module configured to present the plurality of test cases in the chat window.

In some embodiments, the apparatus 500 further includes: a constraint receiving module configured to receive, in the chat window, the test case constraint for the at least one functional block from the user.

In some embodiments, the request receiving module 510 includes: a case request receiving module configured to receive the test case request in response to detecting a preset operation on a test case generation control associated with the at least one functional block.

The modules included in the apparatus 500 may be implemented in various manners, including software, hardware, firmware, or any combination thereof. In some embodiments, one or more modules may be implemented using software and/or firmware, for example, machine-executable instructions stored on a storage medium. In addition to or as an alternative to the machine-executable instructions, some or all of the modules in the apparatus 500 may be implemented at least in part by one or more hardware logic components. By way of example and not limitation, illustrative types of hardware logic components that may be used include a field programmable gate array (FPGA), an application specific integrated circuit (ASIC), an application specific standard product (ASSP), a system on chip (SOC), a complex programmable logical device (CPLD), and the like.

FIG. 6 shows a block diagram of an electronic device 600 in which one or more embodiments of the present disclosure may be implemented. It should be understood that the electronic device 600 shown in FIG. 6 is only illustrative, and should not constitute any limitation to the functions and scope of the embodiments described herein. The electronic device 600 shown in FIG. 6 may be used to run the application creation platform 110 in FIG. 1.

As shown in FIG. 6, the electronic device 600 is in the form of a general-purpose electronic device. The components of the electronic device 600 may include, but are not limited to, one or more processors or processing units 610, a memory 620, a storage device 630, one or more communication units 640, one or more input devices 650, and one or more output devices 660. The processing unit 610 may be a physical or virtual processor and may perform various processing according to a program stored in the memory 620. In a multi-processor system, multiple processing units execute computer-executable instructions in parallel to improve the parallel processing capability of the electronic device 600.

The electronic device 600 typically includes multiple computer storage medium. Such medium may be any available medium accessible by the electronic device 600, including but not limited to volatile and non-volatile medium, removable and non-removable medium. The memory 620 may be volatile memory (e.g., register, cache, random access memory (RAM)), non-volatile memory (e.g., read-only memory (ROM), electrically erasable programmable read-only memory (EEPROM), flash memory), or a combination thereof. The storage device 630 may be a removable or non-removable medium, and may include a machine-readable medium, such as a flash drive, a magnetic disk, or any other medium, which may be capable of storing information and/or data and may be accessed within the electronic device 600.

The electronic device 600 may further include additional removable/non-removable, volatile/non-volatile storage medium. Although not shown in FIG. 6, a disk drive for reading from or writing to a removable, non-volatile magnetic disk (for example, a “floppy disk”), and an optical disk drive for reading from or writing to a removable, non-volatile optical disk may be provided. In these cases, each drive may be connected to a bus (not shown) by one or more data medium interfaces. The memory 620 may include a computer program product 625 having one or more program modules configured to perform various methods or actions of various embodiments of the present disclosure.

The communication unit 640 implements communication with other electronic devices through a communication medium. Additionally, the functions of the components of the electronic device 600 may be implemented in a single computing cluster or multiple computing machines that can communicate through communication connections. Therefore, the electronic device 600 may operate in a networked environment using logical connections to one or more other servers, network personal computers (PCs), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown, such as storage devices, display devices, etc.) as needed through the communication unit 640, communicate with one or more devices that enable users to interact with the electronic device 600, or communicate with any device (for example, a network card, a modem, etc.) that enables the electronic device 600 to communicate with one or more other electronic devices. Such communication may be performed via an input/output (I/O) interface (not shown).

According to an example implementation of the present disclosure, a computer-readable storage medium is provided, which has computer-executable instructions stored thereon, and the computer-executable instructions are executed by a processor to implement the method described above. According to an example implementation of the present disclosure, a computer program product is also provided, which is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of the method, apparatus, device, and computer program product implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a dedicated computer, or other programmable data processing apparatus to produce a machine, so that the instructions, when executed by the processing unit of the computer or other programmable data processing apparatus, produce an apparatus for implementing the functions/actions specified in one or more blocks in the flowcharts and/or block diagrams. These computer-readable program instructions may also be stored in a computer-readable storage medium, and these instructions cause the computer, programmable data processing apparatus, and/or other devices to work in a specific manner, so that the computer-readable medium storing the instructions includes an article of manufacture, which includes instructions for implementing various aspects of the functions/actions specified in one or more blocks in the flowcharts and/or block diagrams.

The computer-readable program instructions may be loaded onto a computer, other programmable data processing apparatus, or other device, causing a series of operational steps to be performed on the computer, other programmable data processing apparatus, or other device to produce a computer-implemented process, such that the instructions executed on the computer, other programmable data processing apparatus, or other device implement the functions/actions specified in one or more blocks in the flowcharts and/or block diagrams.

The flowcharts and block diagrams in the drawings show possible architectures, functions, and operations of the system, method, and computer program product according to multiple implementations of the present disclosure. In this regard, each block in the flowcharts or block diagrams may represent a module, a program segment, or a portion of instructions, and the module, the program segment, or the portion of instructions contains one or more executable instructions for implementing specified logical functions. In some alternative implementations, the functions noted in the blocks may also occur in a different order than the order noted in the drawings. For example, two consecutive blocks may, in fact, be performed substantially concurrently, or the blocks may sometimes be performed in a reverse order, depending upon the functionality involved. It is also noted that each block of the block diagrams and/or flowcharts and combinations of blocks in the block diagrams and/or flowcharts may be implemented by a dedicated hardware-based system that performs the specified functions or actions, or may be implemented by a combination of dedicated hardware and computer instructions.

Various implementations of the present disclosure have been described above, and the above description is illustrative and non-exhaustive, and is not limited to the disclosed implementations. Many modifications and variations will be apparent to those of ordinary skill in the art without departing from the scope and spirit of the described implementations. The selection of terms used herein is intended to best explain the principles, practical applications, or improvements of the technologies in the market, or to enable other ordinary skilled in the art to understand the implementations disclosed herein.

1-13. (canceled)

14. A method for test case generation, comprising:
receiving a test case generation request for at least one functional block in an application;
obtaining a data structure declaration related to a test case of the at least one functional block in response to the test case generation request; and
generating, using a model, a plurality of test cases for the at least one functional block at least based on the data structure declaration and logical architecture information of the at least one functional block.

15. The method according to claim 14, wherein generating the plurality of test cases comprises:
generating a prompt input for the model at least based on the data structure declaration and the logical architecture information, the prompt input indicates a test case generation task;
providing the prompt input to the model;
obtaining, from the model, related information for generating the plurality of test cases; and
generating the plurality of test cases at least based on the related information.

16. The method according to claim 14, wherein generating the plurality of test cases comprises:
obtaining at least one test case sample for the at least one functional block; and
generating, using the model, the plurality of test cases based on the data structure declaration, the logical architecture information, and the at least one test case sample.

17. The method according to claim 14, wherein generating the plurality of test cases comprises:
obtaining a test case constraint for the at least one functional block from a user; and
generating the plurality of test cases based on the data structure declaration, the logical architecture information, and the test case constraint.

18. The method according to claim 14, further comprising:
extracting the logical architecture information from annotation information associated with the application, the annotation information at least describing functions of one or more functional blocks in the application.

19. The method according to claim 14, wherein the logical architecture information indicates at least one of a function description, processing logic, or a calling relationship of the at least one functional block.

20. The method according to claim 14, wherein receiving the test case generation request comprises:
receiving a user input in a chat window between a user and a digital assistant, the user input indicating the test case generation request for the at least one functional block.

21. The method according to claim 20, further comprising:
presenting the plurality of test cases in the chat window.

22. The method according to claim 20, further comprising:
receiving, in the chat window, a test case constraint for the at least one functional block from the user.

23. The method according to claim 14, wherein receiving the test case generation request comprises:
receiving the test case generation request in response to detecting a preset operation on a test case generation control associated with the at least one functional block.

24. An electronic device, comprising:
at least one processor; and
at least one memory coupled to the at least one processor and storing instructions for execution by the at least one processor, the instructions, when executed by the at least one processor, causing the electronic device to perform operations comprising:
receiving a test case generation request for at least one functional block in an application;
obtaining a data structure declaration related to a test case of the at least one functional block in response to the test case generation request; and
generating, using a model, a plurality of test cases for the at least one functional block at least based on the data structure declaration and logical architecture information of the at least one functional block.

25. The electronic device according to claim 24, wherein generating the plurality of test cases comprises:
generating a prompt input for the model at least based on the data structure declaration and the logical architecture information, the prompt input indicates a test case generation task;
providing the prompt input to the model;
obtaining, from the model, related information for generating the plurality of test cases; and
generating the plurality of test cases at least based on the related information.

26. The electronic device according to claim 24, wherein generating the plurality of test cases comprises:
obtaining at least one test case sample for the at least one functional block; and
generating, using the model, the plurality of test cases based on the data structure declaration, the logical architecture information, and the at least one test case sample.

27. The electronic device according to claim 24, wherein generating the plurality of test cases comprises:
obtaining a test case constraint for the at least one functional block from a user; and
generating the plurality of test cases based on the data structure declaration, the logical architecture information, and the test case constraint.

28. The electronic device according to claim 24, wherein the operations further comprises:
extracting the logical architecture information from annotation information associated with the application, the annotation information at least describing functions of one or more functional blocks in the application.

29. The electronic device according to claim 24, wherein the logical architecture information indicates at least one of a function description, processing logic, or a calling relationship of the at least one functional block.

30. The electronic device according to claim 24, wherein receiving the test case generation request comprises:
receiving a user input in a chat window between a user and a digital assistant, the user input indicating the test case generation request for the at least one functional block.

31. The electronic device according to claim 30, wherein the operations further comprises:
receiving, in the chat window, a test case constraint for the at least one functional block from the user.

32. The electronic device according to claim 24, wherein receiving the test case generation request comprises:
receiving the test case generation request in response to detecting a preset operation on a test case generation control associated with the at least one functional block.

33. A non-transitory computer-readable storage medium having a computer program stored thereon, the computer program being executable by a processor to implement operations comprising:
receiving a test case generation request for at least one functional block in an application;
obtaining a data structure declaration related to a test case of the at least one functional block in response to the test case generation request; and
generating, using a model, a plurality of test cases for the at least one functional block at least based on the data structure declaration and logical architecture information of the at least one functional block.
